(19) United States
(12) Patent Application Publication
(10) Pub. No.: US 2024/0028873 A1
(43) Pub. Date: Jan. 25, 2024

(54) METHOD FOR A STATE ENGINEERING FOR A REINFORCEMENT LEARNING SYSTEM, COMPUTER PROGRAM PRODUCT, AND REINFORCEMENT LEARNING SYSTEM

(71) Applicants: Danielle Turner, Nürnberg (DE); Sebastian Pol, Seukendorf (DE); Schirin Bär, Fürth (DE)

(72) Inventors: Danielle Turner, Nürnberg (DE); Sebastian Pol, Seukendorf (DE); Schirin Bär, Fürth (DE)

(21) Appl. No.: 18/023,342

(22) PCT Filed: Aug. 27, 2020
(86) PCT No.: PCT/EP2020/073948

§ 371 Date: Feb. 24, 2023

(51) Int. Cl. G06N 3/0455; G06N 3/092

(52) U.S. Cl. CPC G06N 3/0455; G06N 3/092

(57) ABSTRACT

An update to an encoder is implemented utilizing information regarding performance of a reinforcement learning (RL) agent. This allows the emphasis to be placed not only on improving the performance of the RL agent, but on providing that the data within the encoding is both required and in such a form that it is optimal for the RL agent to learn, thereby reducing complexity and increasing speed of learning.

This application is the National Stage of International Application No. PCT/EP2020/073948, filed Aug. 27, 2020. The entire contents of this document are hereby incorporated herein by reference.

### BACKGROUND

The present embodiments relate to specific and automatic state engineering for a reinforcement learning (RL) system.

The current state of the art involves feeding all information to the agent in the form of a full state, potentially also including information that is not required for decision making, leading to a suboptimal performance of the network.

In the case that not all information is fed directly to the network, manual state engineering is to be carried out to identify and separate the information that is required, which is time intensive and connected to a lot of effort. Further, manual state engineering may be imprecise, as manual state engineering is done using only the best knowledge of the engineer.

Sometimes manual state engineering is done by trial and error (e.g., manually), by observing the performance of the reinforcement learning agent and trying to adapt the state input appropriately.

It is also possible to update hyperparameters with the use of a fitness function to improve the performance of a neural network.

There has been research into the use of autoencoders to encode the input before feeding the input into the reinforcement learning agent (e.g., S. Lange and M. Riedmiller, “Deep autoencoder neural networks in reinforcement learning,” The 2010 International Joint Conference on Neural Networks (IJCNN), Barcelona, 2010, pp. 1-8, doi: 10.1109/IJCNN.2010.5596468).

In this case, the autoencoder was updated when the environment was changed or additional information had to be considered, requiring the autoencoder to be retrained. This encoding does not adapt according to the performance of the reinforcement learning agent. Therefore, this solution does not remove the requirement of manual state engineering, due to the fact that the autoencoder alone simply compresses the information in a different representation, without removing unnecessary details and without selecting the information based on the needs or task of the reinforcement learning agent. This encoding is not guaranteed to be the optimum encoding for the particular solution.

In Van Hoof, N. Chen, M. Karl, P. van der Smagt and J. Peters, “Stable Reinforcement Learning with Autoencoders for Tactile and Visual Data,” Technische Universität Darmstadt, the idea of having a variational autoencoder to provide an encoding for a reinforcement learning agent that is also retrained following a set period was approached. However, this training focuses only on providing that the variational autoencoder may accurately represent the states that the reinforcement learning agent has encountered, which may not have been encountered during pre-training. The experiments described retrain the entire autoencoder.

### SUMMARY AND DESCRIPTION

The scope of the present disclosure is defined solely by the appended claims and is not affected to any degree by the statements within this description.

The present embodiments provide a method for the specific and automatic state engineering for a reinforcement learning (RL) system through coupling the system with an autoencoder. This allows reinforcement learning to be applied to complex environments and state spaces, without requiring a large reinforcement learning network due to giving the whole state to the reinforcement learning agent, and without manually crafting the state input with the possible features needed for decision making.

Particularly for extremely large state sizes, such as with 100,000 values, it is yet unrealistic to give all information explicitly to the reinforcement learning agent. Regarding the hand-crafted feature engineering, it is very difficult to know in advance which information works the best for proper decision making.

Therefore, a solution that allows an adaptive encoding of the state input, which alters the information provided according to the performance of the reinforcement learning agent, and therefore extracts the information pertinent to the particular situation without requiring extensive manual state engineering, is provided.

The present embodiments may obviate one or more of the drawbacks or limitations in the related art. For example, a more flexible solution in which a coupling of both components is provided, and an autoencoder may be adjusted such that the autoencoder would help a reinforcement learning agent to optimally solve a specific task.

A method for an automatic state engineering for a reinforcement learning system, using an autoencoder that is coupled to a reinforcement learning network, where the autoencoder includes an encoder part and a decoder part, includes the following training acts: act 1—training of the autoencoder; act 2—training of the reinforcement learning network with values representing a quality of the reinforcement learning network or Training; and act 3—retraining of the encoder part (E) by using results of act 2.

The method focuses on implementing an update to the encoder part of the autoencoder by utilizing information regarding a performance of the reinforcement learning RL agent. This allows the emphasis to be placed not only on improving the performance of the RL agent, but on providing that the data within the encoding is both required and in such a form that it is optimal for the reinforcement learning agent to learn, thereby reducing complexity and increasing speed of learning.

The experiments described in Van Hoof et al. retrain the entire autoencoder, while the procedure in the present embodiments retrains only the encoder part, allowing for unnecessary information to be discarded by the network, and creating an encoding that is specific to the task of the reinforcement learning agent.

In order to reduce the dimensionality of the state input for the reinforcement learning agent, while providing that the encoded state is optimized for use with the reinforcement learning agent trained for a certain task, an autoencoder is coupled to the reinforcement learning agent. Depending on the format of the data, this autoencoder may be of any type (e.g., Convolutional Autoencoder for encoding of images, Deep Autoencoder, etc.), as may the reinforcement learning algorithm that is used (e.g., DQN Deep Q-Network, DDPG Deep Deterministic Policy Gradient, or the like).

### BRIEF DESCRIPTION OF THE DRAWINGS

FIG. 1 illustrates an example of three acts of a method;

FIG. 2 is a schematic picture of the basic principle;

FIG. 3 a first example of a method used for a flexible manufacturing system (FMS);

FIG. 4 is a first example of a method with example information; and

FIG. 5 is a second example of an embodiment used for images of scanned objects.

### DETAILED DESCRIPTION

The examples shown in the figures are only used to clarify the present embodiments but not meant to limit the invention beyond the scope of the claims.

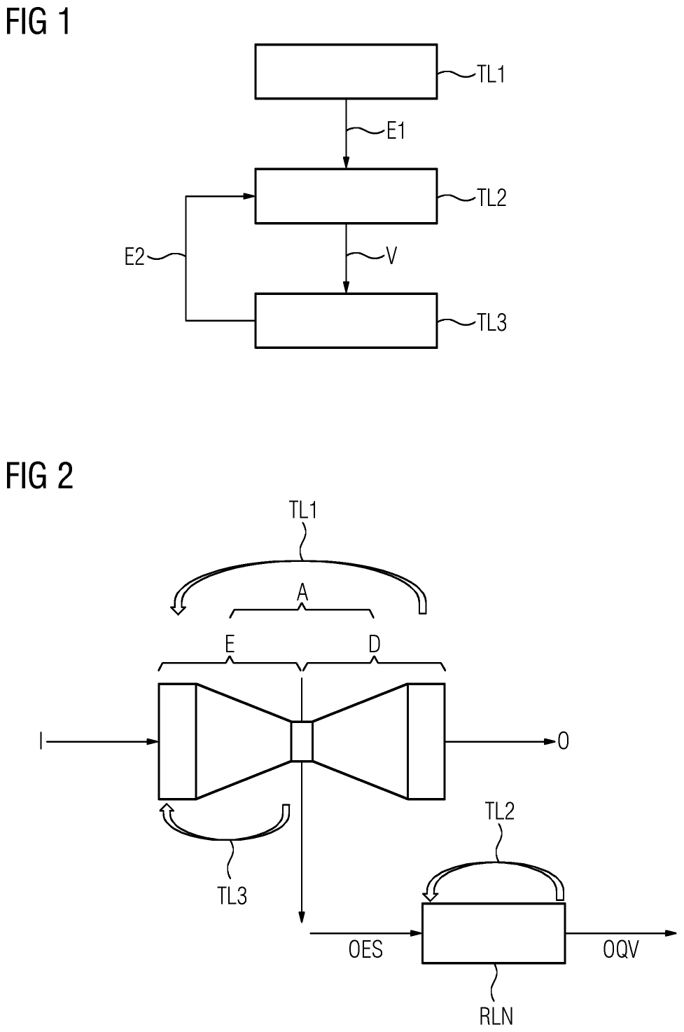

FIG. 1 shows a brief overview of the training loops in this implementation and the information shared between training loops: Training Loop 1 TL1—Train autoencoder; Training Loop 2, TL2—Train Reinforcement Learning Agent; Training Loop 3, TL3—Retrain Encoder.

Training is then carried out in three distinct training loops TL1, TL2, TL3, the latter two of which are then repeated until a suitable solution is found. These training loops are described generally in FIG. 1, and in more detail in FIG. 2.

Between Training Loops 1 and 2, TL1, TL2, Encoding, E1, is performed. The autoencoder is to first be trained to provide that the encoding represents the state well enough for a reinforcement learning agent to learn, before Training Loops 2 and 3 may then iteratively refine this solution. After Training loop TL2, an output is a value or values representing a quality of a reinforcement learning network (e.g., loss, rewards, or gradient).

The first of these training loops is to pre-train the autoencoder to output O a state that is indistinguishable from the state that has been input. As a number of nodes in each layer is first decreased, in encoder-part E of the autoencoder A, and then increased to the original size, in decoder-part D of the autoencoder A, a middle layer of an adequately trained autoencoder A may be used as an encoding of the state.

After pre-training the autoencoder A, a state I that would normally be used as an input to a reinforcement learning (RL) agent is first fed into the trained encoder E, an output OES provides an encoded input E1 for the RL agent. This provides a compressed version of the input state and does not yet consist of the specific information needed for the task of the RL Agent.

This encoding loop TL2 is then used for each time step in which decision-making is to be performed, along with interaction with an environment, to train the network RLN of the RL agent in the second training loop TL2, through the usual procedure of the relevant reinforcement learning.

The third training loop TL3 uses information gathered from the training of the RL agent RLN to update the encoder E, with the aim of improving the encoding and consequently improving the performance of the RL agent. This information OQV may consist of the losses, rewards, or gradients collated from the training of the RL agent, or anything indicating the performance of the RL agent that may be used to update the Encoder, such that the encoding improves, allowing the RL agent to perform better, specifically with the intention of engineering the state automatically.

For example, the gradients from the update of the RL agent may directly be used together with sampled policy gradient in order to update the encoder network.

The second and third training loops TL2, TL3 are performed iteratively, for example, switching between the second and third training loops TL2, TL3 after every epoch, to continuously improve the encoding provided to the RL agent. More generally, the training circles are organized in episodes (e.g., a fixed number of steps or the achievement of a certain training goal). Collecting a certain number of training episodes may be referred to as a training epoch (e.g., either a fixed number or any other indication for a useful defined end).

In the case of multiple different reinforcement learning agents AG (e.g., incarnations of the reinforcement learning network RLN provides utilizing the same RL network RLN), but each with a different optimization goal fitted to its task, it would be possible to introduce a condition to the autoencoder that separates the encoding of the various optimization goals while providing that there is no overlap between the optimization goals. This would allow different information to be encoded such that it is understandable for the RL agent, and allow a specific encoding for each optimization goal, without compromising the performance of the network.

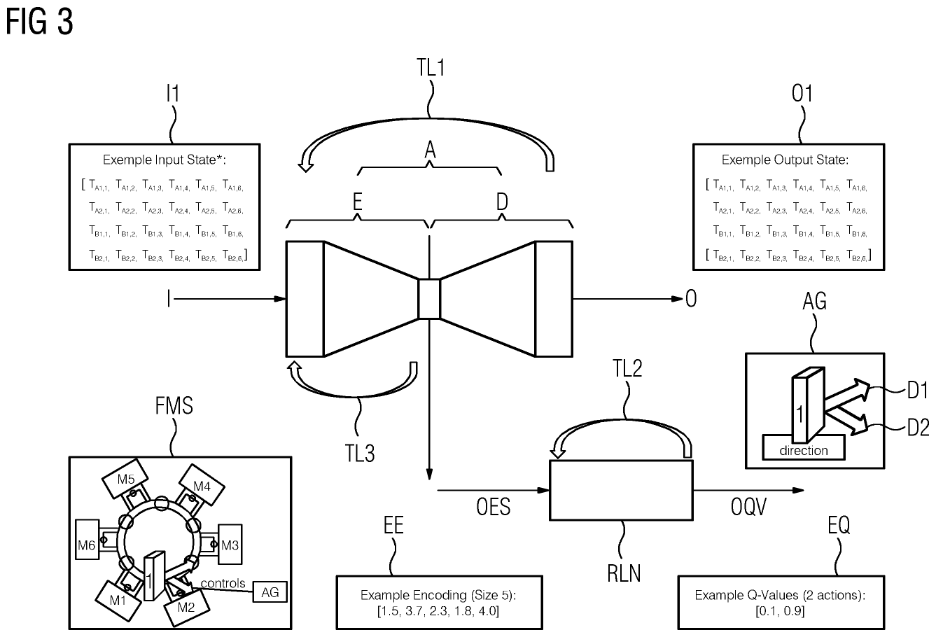

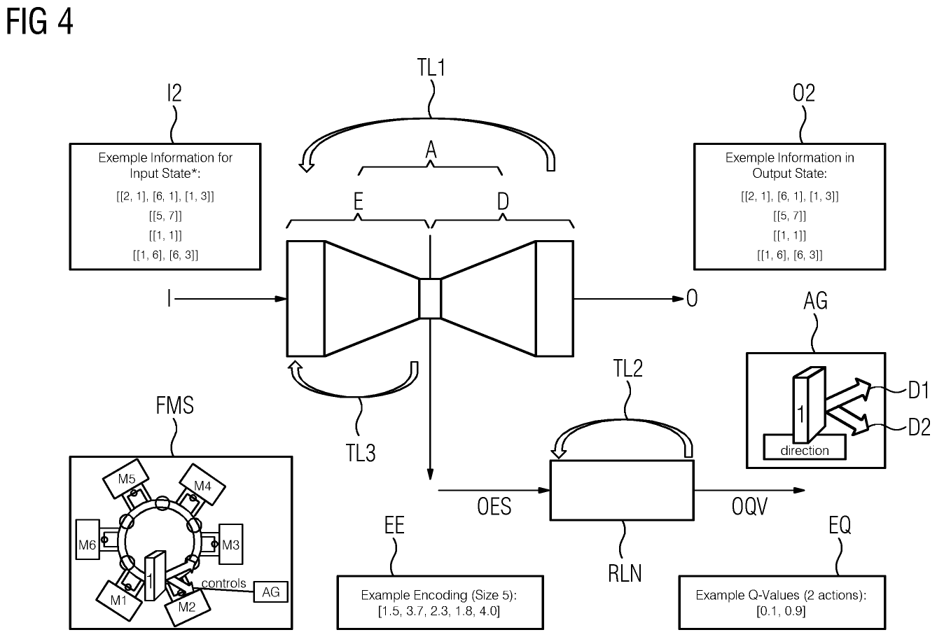

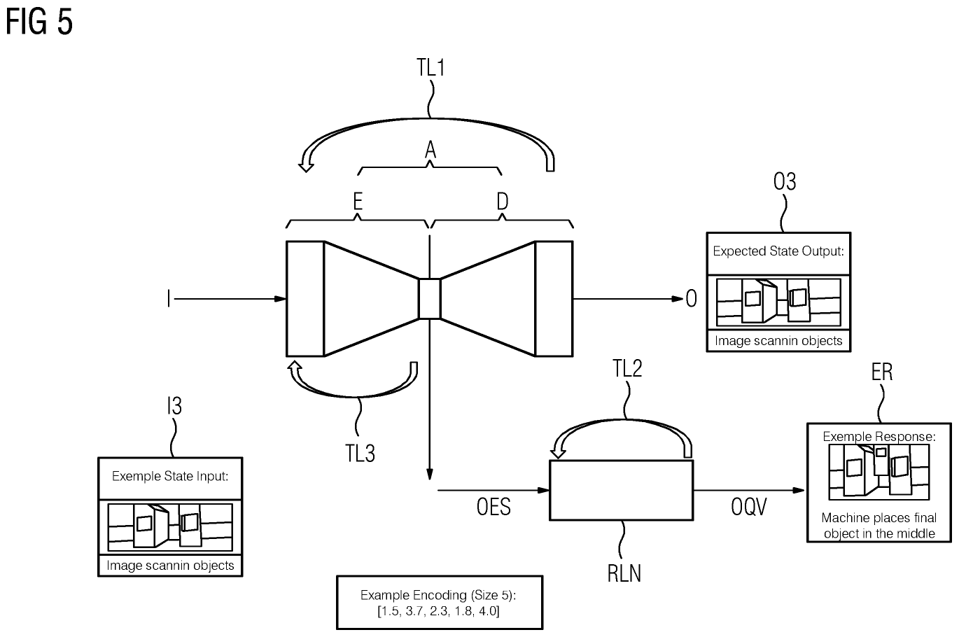

This implementation may, for example, be used for the scheduling of products 1 through manufacturing systems FMS or any other environments, as shown in the examples of FIGS. 3 and 4. In the manufacturing domain, each reinforcement learning agent AG may control a certain product 1 through a flexible manufacturing system FMS, where modules M1, . . . M6 may be docked, undocked, and changed, and products may have various job specifications.

The job specifications describe which modules M1, . . . M1 may perform the required operations of processing and provide a value representing the suitability of each of these modules for an optimization goal (e.g., the ability, such as the time taken to perform an operation to minimize the makespan).

In this simple example, the agent AG may be trained to decide, for the next processing step for the workpiece 1 after being processed in Module M1 of the flexible manufacturing system FMS, the first direction D1, what means being transported next to module M3 for processing, or the second direction D2, where the module M2 would be the next processing station.

In a job-specification, each operation is labeled by one or more elements [M,P] where M references a manufacturing module and P is a property such as the corresponding processing time or energy consumption.

The example input state I1 may be a matrix as follows (and the expected output state O1 as well):
[T_{A1,1} T_{A1,2} T_{A1,3} T_{A1,4} T_{A1,5},
T_{A2,1} T_{A2,2} T_{A2,3} T_{A2,4} T_{A2,5},
T_{B1,1} T_{B1,2} T_{B1,3} T_{B1,4} T_{B1,5},
T_{B2,1} T_{B2,2} T_{B2,3} T_{B2,4} T_{B2,5}]

The example Information for input state I2, which may also be the expected information in the output state O2 in FIG. 4 is more specific and may look like the following:
[[2, 1], [6, 1], [1, 3]]
[[5, 7]]
[[1, 1]]
[[1, 6], [6, 3]].

The example Encoding EE in Size 5 may then be in both examples:
[1.5, 3.7, 2.3, 1.8, 4.0]

And the example Q-values EQ for 2 actions may be
[0.1, 0.9]

Should the Flexible Manufacturing System FMS control multiple products, the information regarding these products is to be passed to the reinforcement learning agent AG in order to provide an optimum schedule. However, in the case of a large number of products, the size of the network of the RL scales to an impractical size, making it difficult for the agent to learn, potentially increasing training time and effort, and possibly also causing the agent to be unable to converge to the solution.

In order to combat this, a deep autoencoder A may be trained to encode the state input I, which in this case may include information from the FMS, such as the job specification of all agents, the modules within the FMS and their locations, and the locations of all agents within the FMS. In the case of many products, each with a different job specification, the state may become very large. To solve this, the state is fed into a deep autoencoder that is first trained on randomly generated or collected states to provide that the encoding is a correct representation of the information.

A Deep Q-Network (DQN) agent may then be trained using these encoded states, interacting with the environment to control the products to the correct modules while adhering to the minimum makespan. The gradients that result from each calculation of the reinforcement learning agent network update are then passed to the encoder E in order to update the weights of the encoder, using a Sampled Policy Gradient (SPG) algorithm, which allows the encoder to attempt to maximize the performance of the DQN Agent by adjusting the state encoding in the required direction. The process of training the RL agent, feeding the gradients to the encoder, and updating the encoder is performed until the performance of the RL agent reaches the desired level. The state encoding is thereby customized for the considered RL agent to achieve the best results.

In FIG. 5, another example of application of the proposed method is provided, where the state input I3 and output O3 are images of scanned objects, not matrices of numbers as in the two examples above (e.g., again in a Flexible Manufacturing System FMS, but other fields of application are possible). As shown on the picture I3, two workpieces with markings on left side and right side with a gap in between, the goal of the training may then be to enable, for example, a module to place a third part in the gap between those two workpieces, which are eventually marked to be easier recognized by the visual scanner, depicted in the output ER.

The proposed solution has the advantage that there is no more need for manual state engineering. Further, a more specific encoding is achieved, including only information that is necessary for the reinforcement learning, providing that training the RL agent is more efficient.

By using the autoencoder A for dimensionality reduction instead of the reinforcement learning agent AG, a more efficient and faster learning is achieved due to simplicity of training using, for example, Mean Squared-Error.

As the tasks are split between two components, each component may focus more on the aspect that the respective component is to learn (e.g., the autoencoder focuses on reducing the dimensionality of the state, and the RL agent focuses on decision making to provide the solution), which may improve results and/or speed of learning.

The autoencoder may be used to generate state encodings that are customized to different optimization objectives (e.g., when the respective autoencoder is improved by coupling the respective autoencoder with the RL agent that is trained for a specific objective). This may improve the performance of the RL agents, as the RL agents may receive a specific state encoding with respect to the desired optimization objective.

While the present disclosure has been described in detail with reference to certain embodiments, the present disclosure is not limited to those embodiments. In view of the present disclosure, many modifications and variations would present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within the scope.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method for an automatic state engineering for a reinforcement learning system, wherein an autoencoder is coupled to a reinforcement learning network (RLN), the autoencoder including an encoder part and a decoder part, the method comprising:
training the autoencoder;
training the RLN with values representing a quality of the RLN or the training of the RLN; and
retraining the encoder part of the autoencoder using results of the training of the RLN,
wherein the method is used for a manufacturing system, the manufacturing system including processing entities that are interconnected,
wherein manufacturing scheduling of a product is controlled by a reinforcement learning agent of the reinforcement learning network and learned by the reinforcement learning system,
wherein each reinforcement learning agent of the reinforcement learning network is configured to control one product with a job specification, and
wherein the method further comprises providing a value representing a suitability of each of the processing entities for an optimization goal.

2. The method of claim 1, wherein the training of the autoencoder and the training of the RLN are performed iteratively, switching between the training of the autoencoder and the training of the RLN after a defined number of steps of training the reinforcement learning agent.

3. The method of claim 1, wherein there are at least two reinforcement learning agent instantiations of the RLN,
wherein each reinforcement learning agent of the at least two reinforcement learning agent instantiations has an optimization goal for the training of the reinforcement learning agent,
wherein the autoencoder uses condition information about the reinforcement learning agent that separates the encoding of the respective optimization goal of the reinforcement learning agent.

4. The method of claim 1, wherein the manufacturing scheduling is a self-learning manufacturing scheduling, and the manufacturing is a flexible manufacturing system,
wherein the method further comprises:
producing at least one product; and
applying training on an optimization goal of the at least one product.

5. The method of claim 1, wherein the reinforcement learning agent is a Deep Q-Network DQN-Agent, and gradients that result from each calculation of a reinforcement learning agent network update are then passed to the encoder part of the autoencoder to update weights of the encoder part using a Sampled Policy Gradient algorithm.

6. (canceled)

7. A reinforcement learning system comprising:
an autoencoder coupled to a reinforcement learning network (RLN), the autoencoder including an encoder part and a decoder part,
wherein the reinforcement learning system is configured to:
train the autoencoder in a first step;
train the RLN in a second step with values representing a quality of the RLN or the training of the autoencoder; and
retrain the encoder part in a third step using results of the second step.

8. In a non-transitory computer-readable storage medium that stores instructions executable by one or more processors for an automatic state engineering for a reinforcement learning system, wherein an autoencoder is coupled to a reinforcement learning network (RLN), the autoencoder including an encoder part and a decoder part, the instructions comprising:
training the autoencoder;
training the RLN with values representing a quality of the RLN or the training of the RLN; and
retraining the encoder part of the autoencoder using results of the training of the RLN,
wherein the method is used for a manufacturing system, the manufacturing system including processing entities that are interconnected,
wherein manufacturing scheduling of a product is controlled by a reinforcement learning agent of the reinforcement learning network and learned by the reinforcement learning system,
wherein each reinforcement learning agent of the reinforcement learning network is configured to control one product with a job specification, and
wherein the instructions further comprise providing a value representing a suitability of each of the processing entities for an optimization goal.

9. The non-transitory computer-readable storage medium of claim 8, wherein the training of the autoencoder and the training of the RLN are performed iteratively, switching between the training of the autoencoder and the training of the RLN after a defined number of steps of training the reinforcement learning agent.

10. The non-transitory computer-readable storage medium of claim 8, wherein there are at least two reinforcement learning agent instantiations of the RLN,
wherein each reinforcement learning agent of the at least two reinforcement learning agent instantiations has an optimization goal for the training of the reinforcement learning agent,
wherein the autoencoder uses condition information about the reinforcement learning agent that separates the encoding of the respective optimization goal of the reinforcement learning agent.

11. The non-transitory computer-readable storage medium of claim 8, wherein the manufacturing scheduling is a self-learning manufacturing scheduling, and the manufacturing is a flexible manufacturing system,
wherein the instructions further comprise:
producing at least one product; and
applying training on an optimization goal of the at least one product.

12. The non-transitory computer-readable storage medium of claim 8, wherein the reinforcement learning agent is a Deep Q-Network DQN-Agent, and gradients that result from each calculation of a reinforcement learning agent network update are then passed to the encoder part of the autoencoder to update weights of the encoder part using a Sampled Policy Gradient algorithm.
